(19) United States
(12) Patent Application Publication
(10) Pub. No.: US 2017/0103374 A1
(43) Pub. Date: Apr. 13, 2017

(54) SYSTEMS AND METHODS FOR DETERMINING CURRENTLY AVAILABLE CAPACITY FOR A SERVICE PROVIDER

(71) Applicant: MasterCard International Incorporated, Purchase, NY (US)

(72) Inventors: Manash Bhattacharjee, Jersey City, NJ (US); Debashis Ghosh, Charlotte, NC (US); Randy Shuken, Westport, CT (US)

(21) Appl. No.: 14/881,244

(22) Filed: Oct. 13, 2015

(51) Int. Cl. G06Q 20/20

(52) U.S. Cl. CPC G06Q 20/204; G06Q 20/202; G06Q 20/203

(57) ABSTRACT

A computer-based method for reporting capacity for a merchant is provided. The method is implemented using a capacity monitoring (CM) computing device, and includes receiving merchant data for a merchant via a merchant computing device and payment transaction data for a transaction performed at the merchant via a point-of-sale (POS) computing device, wherein merchant data includes an average consumer count and a total occupancy count. The method also includes calculating a peak transaction count for the merchant for a predetermined time period and a current transaction count corresponding to a current transaction time included within the predetermined time period. The method also includes determining a capacity count for the predetermined time period based on the peak transaction count, the current transaction count, and average consumer count, and transmitting the capacity count to a consumer computing device, wherein the capacity count indicates a remaining consumer capacity for the merchant.

### BACKGROUND OF THE DISCLOSURE

This disclosure relates generally to monitoring available capacity for a service provider and, more specifically, to systems and methods for using historical payment card transaction data to determine currently available capacity for a service provider.

Capacity within a service provider, such as an eating establishment, may refer to a number of open tables or seats or standing room. Consumers interested in dining or drinking at a restaurant or bar can be accommodated by the service provider provided there is sufficient capacity, or the consumers must be sure to make a reservation prior to their visit. At peak times, such as at lunch, dinner, holiday times, or during special events, consumers may be turned away or given long wait times (assuming they have not made a reservation) from a restaurant since the restaurant is full and has insufficient capacity at that time. To avoid this, consumers need to call to inquire if reservations are accepted. At peak times, consumers may be forced to contact multiple establishments before determining one that can accommodate them and may end their search before a suitable location is found. As a result, consumers are oftentimes unable to easily find a restaurant or bar able to timely serve them, and service establishments with available space are unable to connect with interested consumers.

Known systems for managing consumer wait times at an eating establishment are very limited. These known systems merely allow a consumer to determine capacity for a single restaurant or bar using a dedicated restaurant application. These known systems are further limited in that the input information processed by these systems is data that is manually inputted by a manager of the eating establishment, and thus, the outputted results are frequently inaccurate. Other known systems require restaurants to pay a fee and sign up to use an application to update capacity levels after a consumer has already entered the restaurant. But this requires a separate, slow process that necessitates diligent and accurate manual data entry by restaurant owners to keep capacity variable(s) current. Even with perfect logging of capacity updates, these applications are limited to only those establishments which contract with them and pay the fee, limiting consumer choice and transferring costs on to consumers as well. Additionally, these systems are unable to account for seasonal and intraday variations in restaurant and bar capacity.

### BRIEF DESCRIPTION OF THE DISCLOSURE

In one embodiment, a computer-based method for reporting capacity for a merchant is provided. The method is implemented using a capacity monitoring (CM) computing device, and includes receiving merchant data for a merchant via a merchant computing device and payment transaction data for a transaction performed at the merchant via a point-of-sale (POS) computing device, wherein merchant data includes an average consumer count and a total occupancy count. The method also includes calculating a peak transaction count for the merchant for a predetermined time period and a current transaction count corresponding to a current transaction time included within the predetermined time period. The method also includes determining a capacity count for the predetermined time period based on the peak transaction count, the current transaction count, and average consumer count, and transmitting the capacity count to a consumer computing device, wherein the capacity count indicates a remaining consumer capacity for the merchant.

In another embodiment, a computer system for reporting capacity for a merchant is provided. The system comprises a capacity monitoring (CM) computing device. The CM computing device is configured to receive merchant data for a merchant via a merchant computing device, receive payment transaction data for at least one transaction performed at the merchant via a point-of-sale (POS) computing device, wherein merchant data includes an average consumer count and a total occupancy count, calculate a peak transaction count for the merchant for a predetermined time period, calculate a current transaction count corresponding to a current transaction time included within the predetermined time period, determine a capacity count for the predetermined time period based, at least in part, on the peak transaction count, the current transaction count, and the average consumer count, and transmit the capacity count to a consumer computing device, wherein the capacity count indicates a current remaining consumer capacity for the merchant.

In yet another embodiment, a non-transitory computer readable medium that includes computer executable instructions for reporting capacity for a merchant is provided. When executed by a capacity monitoring (CM) computing device in communication with a processor and a memory device, the computer executable instructions cause the CM computing device to receive merchant data for a merchant via a merchant computing device, receive payment transaction data for at least one transaction performed at the merchant via a point-of-sale (POS) computing device, wherein merchant data includes an average consumer count and a total occupancy count, calculate a peak transaction count for the merchant for a predetermined time period, calculate a current transaction count corresponding to a current transaction time included within the predetermined time period, determine a capacity count for the predetermined time period based, at least in part, on the peak transaction count, the current transaction count, and the average consumer count, and transmit the capacity count to a consumer computing device, wherein the capacity count indicates a current remaining consumer capacity for the merchant.

### BRIEF DESCRIPTION OF THE DRAWINGS

FIGS. 1-7 show example embodiments of the methods and systems described herein.

FIG. 1 is a schematic diagram illustrating an example multi-party transaction card industry system for authorizing payment card transactions in which parties provide processing services to various financial entities.

FIG. 2 is a simplified data flow diagram of an example capacity monitoring system.

FIG. 3 illustrates an example payment processing environment in which a capacity monitoring system operates in conjunction with a payment processor.

FIG. 4 illustrates an example configuration of a user system operated by a user, such as a merchant or consumer.

FIG. 5 illustrates an example configuration of a server system used for monitoring capacity.

FIG. 6 shows an example method by which a capacity monitoring computing device determines and transmits capacity information.

FIG. 7 shows an example configuration of a database within a computing device that may be used to monitor capacity for a merchant.

Like numbers in the Figures indicate the same or functionally similar components.

### DETAILED DESCRIPTION OF THE DISCLOSURE

The systems and methods described herein include a Capacity Monitoring (CM) computing device that is used for monitoring available capacity in a service provider establishment, such as a restaurant or bar. More specifically, the CM computing device is configured to provide to a consumer, for example, an accurate number of unused seats or tables within a restaurant in near real-time to enable the consumer to determine whether or not to visit the restaurant. In at least some implementations, the CM computing device is in communication with a payment processor that processes payment card transactions, such as for credit and debit cards. The payment processor is also in communication with issuing banks that issue payment cards to consumers (also referred to herein as “cardholders”), and acquiring banks that hold accounts for merchants. The payment processor is further connected to millions of point-of-sale (POS) devices that transmit data relating to a transaction.

For example, a cardholder and his family may order a meal at a restaurant. A restaurant employee (e.g., a server) will enter details of the order (e.g., food and drink items ordered, table number, consumer count, etc.) into a merchant device. In one embodiment, a merchant device is any computing device that is configured to electronically receive order details, transmit order details to the kitchen, print receipts, store reservations, or the like. At the end of the cardholder's visit, the cardholder pays for the meal using a payment card associated with the cardholder's payment account. The restaurant employee charges the cardholder's account for the meal by swiping payment card or other otherwise entering details of the payment card at the restaurant's POS device. In one embodiment, the POS device is a combination of payment card processing device and merchant device. In other words, the restaurant employee both enters order details and charges the payment card using a single device. In another embodiment, the POS device is a payment card processing POS device that only receives payment card data and transmits it to the payment processor, while order details are entered into the merchant device or on physical media (e.g., paper). In still other embodiments, the order details are entered in a merchant device that is connected to the payment card processing POS device.

Data generated from the above-mentioned visit by the cardholder to the restaurant may be grouped under two labels: transaction data and order data. Transaction data includes, for example, a payment card transaction time, date, amount, the transacting merchant, the payment card used by the cardholder, any related data such as special payment processor products or services used in the transaction, or the like. Order data may include some data points such as date, transaction open time, transaction close time, items purchased, number of consumers/cardholders for the visit, table number at a restaurant, server name, or the like.

As used herein, “transaction open time” may refer to at least two different points in time. Where a consumer pays at a restaurant at the beginning of a meal (e.g., in line at a fast-casual eatery) using the consumer's payment card, transaction open time is the time at which the consumer swiped or otherwise used his payment card to perform the transaction. Where a restaurant employee charges a payment card at the end of a meal (e.g., at an upscale restaurant), the CM computing device determines transaction open time using order data, i.e., based on when the server initially entered the food/drink orders for the consumer(s) into the merchant device or POS device.

As used herein, “transaction close time” may refer to one or more points in time. Where a consumer pays at the end of a meal, transaction close time is the timestamp of the consumer's card swipe or other card charging method. However, in embodiments where the consumer pays at the beginning, the CM computing device determines transaction close time by adding “average transaction duration” to the transaction open time. Average transaction duration is the average length of time a consumer is in the restaurant or is occupying a seat at the restaurant. In one embodiment, the CM computing device calculates average transaction duration at similar merchants using the difference between transaction open time and transaction close time, where both times are known. Examples of this include a restaurant where order data reveals when the server entered the order and cardswipe/payment data represents transaction close time, or a bar where a server takes a consumer's payment card and opens a “tab” or an account that is closed at the conclusion of the consumer's visit, such that the card is swiped once each at tab open and tab close, giving the transaction open time and transaction close times.

In another embodiment, the consumer pays at the beginning but then there is no subsequent interaction with the merchant device or POS device. The consumer simply leaves at the conclusion of his visit. In such cases, the CM computing device is configured to receive average transaction duration data from sample studies. For example, a sample study at such a “pay-at-start” restaurant may disclose that, on average, consumers stay at the restaurant for 45 minutes. The sample study may also provide the average number of consumers that order items for takeout or “to-go.” Such consumers, though generating transaction data, may be irrelevant to determining capacity at the restaurant and thus their data may be removed from the transaction data used by the CM computing device.

The CM computing device is configured to receive transaction data and order data regardless of the payment processor involved or type of POS device used. Restaurants and bars will contract with one or more payment processors to process their payment card payments. A payment processor may be a member of a larger payment processing network. Relatedly, these restaurants and bars will have POS devices configured to send and receive transaction data to the respective payment processors. An exemplary restaurant R may contract with payment processors A and B, whereas another restaurant S may contract with payment processors B, C, and D. Payment processor A will receive transaction data (and possibly order data) from restaurant R for transactions processed by payment processor A. But payment processor A may not have visibility to transactions that occurred at restaurant R via payment processor B, or to any transactions at restaurant S. In other words, the CM computing device is configured to receive data from any payment processor, as explained in more detail below.

In at least some implementations, the CM computing device receives transaction data from the payment processor and receives order data via a cloud-based API platform that functions as a middleware API layer. This API layer enables the CM computing device to receive order data that is generated at POS devices or at merchant devices. Merchant devices may also connect via the API layer to transmit merchant registration data during a signup process for the capacity monitoring service offered by the CM computing device. The API layer is configured to interoperate with a plurality of different POS device and/or merchant device providers, which may use otherwise incompatible technology. The API layer exposes objects (software components) that represent multiple data collection points that multiple POS devices and merchant devices can communicate with to provide transaction data. Additionally, the CM computing device need not rely on manual data entry to refresh the data, as data from each transaction flowing through any POS or merchant device is captured and available to the CM computing device. The API layer receives transaction data from the payment processor but also transaction data for transactions performed using payment cards that are not affiliated with that payment processor or payment processing network. Accordingly, the API layer receives transaction data for payment cards that are issued as part of any payment processing network, not just the payment processing network that has the payment processor as a member.

Finally, the CM computing device is also in communication with consumer computing devices (e.g., mobile devices, laptops, desktops owned by cardholders etc.) to which the CM computing device transmits capacity data and from which the CM computing device receives feedback regarding the accuracy of the provided capacity data. In one embodiment, the CM computing device transmits capacity data to a software application (“app”) running on a consumer computing device.

In at least some implementations, the CM computing device calculates a “current transaction count” for a particular time period, such as an hour, a day, or a week. The current transaction count is a count of all transactions received by the payment processor and accessible by the CM computing device. In other embodiments, the current transaction count is determined from order data (i.e., the number of orders at the restaurant is used as a proxy for current transaction count). The CM computing device is configured to receive order data for all orders at a particular merchant, not just orders that were paid for using a payment card that is, for example, a member of a particular payment processing network.

The API layer is also configured to receive, from POS or merchant devices, merchant registration data that is used to drive the functions of the CM computing device. Merchant registration data includes at least a total possible occupancy and an “average consumer count” per transaction for a particular establishment, such as a restaurant. For example, a restaurant manager may use a merchant device to communicate the total number of seats in his/her restaurant (possibly broken down by seasons, lunch/dinner times etc.) and his/her estimate of the average consumer count (i.e., the average number of people per check for the restaurant). In addition, or alternatively, the restaurant may provide a sample of daily consumer totals at the restaurant. Merchants may also provide other merchant characteristic data. This may include data points such as whether the merchant has consumers pay at the beginning or pay at the end, and whether the merchant will transmit both a transaction open time and a close time (e.g., where a bartender opens and closes a tab). Other merchant characteristic data includes, for example, whether the merchant's servers mark a table as occupied the moment consumers are seated, or if a table is marked as occupied only several minutes later (e.g., when a server enters the consumers' entrée orders).

Merchants may also provide optional additional data, including periodic statistics on peak capacity, either using a tracker embedded in the merchant device, or via the merchant's own estimates of peak. Merchants may also indicate unusual changes to capacity (e.g., if the entire restaurant is scheduled to be closed for a specific event). The CM computing device is configured to incorporate the merchant characteristic data and optional additional data into its determination of capacity. For example, the CM computing device is configured to account for merchant-provided peak capacity statistics and dynamically update its calculations of, for example, peak transaction count (discussed below). CM computing device is also configured to, for example, perform an override function on any capacity estimate it has determined in case the merchant indicates that there is no capacity due to a private event on a particular day.

Additionally, the CM computing device receives data regarding the number of consumers visiting the establishment that is developed using periodic sample studies and/or received from other data sources (e.g., associated restaurant databases storing other transaction details like consumer counts, menu items, etc.). For example, sample studies can provide data used to calculate the average consumer count per transaction. Multiple studies may be done for different neighborhoods and tabulated against transaction data from those neighborhoods.

The average consumer count per transaction (“average consumer count”) determined from sample studies or provided by restaurants in merchant registration data is a static data point. However, in at least some implementations, the CM computing device combines this static data with transaction data to determine a dynamically generated average consumer count. For example, knowing the daily consumer totals (from merchant registration data or periodic updates) and corresponding transactions for that day (“current transaction count”), the CM computing device can determine the average consumer count for that day by dividing the daily consumer total by the transaction count. For example, the CM computing device may use the merchant-provided average consumer count as a seed value that is progressively refined using a calculation of merchant-provided daily consumer total divided by transaction count. In some embodiments, the CM computing device determines average consumer count by season, or day of the week, or predefined time slots per day.

In addition, using transaction data, the CM computing device also determines an “average peak transaction count” for each time slot for an associated restaurant. For example, the CM computing device may, using historical transaction data, divide the lunch time slot (e.g., 11:00 AM-3:00 PM) into eight 30-minute time slots. The CM computing device may then determine the highest, or peak, number of transactions for each of the eight time slots (e.g., over the past two years). In other implementations, the CM computing device may take an average of a predetermined number of highest transaction counts for a time slot (e.g., retrieve the top 20 transaction counts for 11:00 AM to 11:30 AM over the past two years, and take the average). In at least some implementations, the CM computing device then multiplies the average peak transaction amount and the average consumer count to determine an average peak occupancy per time slot for a restaurant.

In another embodiment, the CM computing device subtracts the current transaction count from the average peak transaction count. The difference (“transaction differential”) represents a number of transactions that can still be performed at the restaurant for that time slot without reaching a maximum (i.e. the average peak transaction count that was previously calculated). The CM computing device then multiplies the transaction differential by the average consumer count, to obtain a capacity count for the restaurant. In other words, the number of possible additional transactions times an average number of consumers per transaction gives a measure of how many more consumers the restaurant can accommodate.

For example, assume that a restaurant opens at 12:00 PM. At 12:00 PM, the number of consumers in the restaurant is zero. In the 12:00 -12:30 time slot, a restaurant has an average peak transaction count of 30. At 12:10 PM, the current transaction count in the restaurant for 12:00-12:30 is 10. Then the transaction differential is 20. Given an average consumer count for the restaurant of 2 consumers per transaction, the CM computing device determines a capacity count of 2×20=40. Therefore, the restaurant can accommodate at least another 40 consumers during the 12:00-12:30 time slot. The CM computing device is configured to continually receive transaction data or order data for this restaurant from the payment processor or the merchant device associated with this restaurant to determine the capacity count and communicate to a consumer computing device operated by a user who is interested in learning whether the restaurant has adequate capacity for the user to pay a visit.

The CM computing device is also configured to account for consumers who may be in the restaurant from the previous time slot. This may be necessary at bars and at “pay-at-start” restaurants where the transaction close time is not directly transmitted from the POS device, and thus it may not be known when a consumer may have vacated his seat. For example, assume that in the 12:30-1:00 PM time slot, the restaurant has an average peak transaction count of 40, and average consumer count is still 2 consumers per transaction. At 12:40 PM, the current transaction count for 12:30-1:00 PM is 10. Then the transaction differential is 30. But the average transaction duration (i.e., the average amount of time a consumer is in the restaurant), is 45 minutes. Therefore, for example, any consumers that walked in at 12:00 PM are likely to still be there at 12:40 PM, occupying seats. The CM computing device is configured to add the average transaction duration to the timestamp for each transaction to generate the transaction close time, providing a measure of when the corresponding consumer(s) will exit the restaurant. Assume that, between 12:00 PM and 12:40 PM, there were a total of 20 transactions. The transaction differential can be calculated by subtracting this total from the average peak transaction count for the combined time slot of 12:00-1 PM (e.g., 38). Then the transaction differential is 18 and the CM computing device determines a capacity count of 18×2=36 (i.e., 36 consumers can be accommodated in the restaurant).

In another embodiment, a weighting is applied to account for consumers that are still occupying seats from the previous time slot, particularly in the bar environment. First, time slot duration is determined (e.g., 30 minutes). Then, currently received transaction data is analyzed to determine “current time slot open transactions,” i.e., the number of transactions currently open at the bar, based on transaction open time. Similarly, “previous time slot open transactions” are determined, i.e., i.e., the number of transactions opened at the bar in the previous time slot, based on transaction open time. Additionally, the CM computing device calculates historical values for both, i.e., “historical current time slot open transactions” and “historical previous time slot open transactions.” Using the historical values, statistics for the previous time slot are weighted against those for the current time slot in order to determine capacity.

For example, assume a bar is using 30 minutes as time slot and, currently, it is 6:00 PM on a Friday on June 26 2015. In the past (e.g., on June 26, in previous years, or the last Friday in June on previous years, or similar) historical current time slot open transactions for this time slot (i.e., 5:30 PM to 6:00 PM) has been 300, and historical previous time slot open transactions for the previous 30 minutes (i.e., 5:00 PM to 5:30 PM) has been 265. Currently received data shows current time slot open transactions at previous time slot open transactions at 200. Assume that transactions from the previous time slot are weighted at 30%, (e.g., to denote that consumers who opened transactions from the previous time slot are 30% likely to still be occupying seats in the current time slot). Assume also that transactions from the current time slot are weighted at 70% (e.g., to denote that consumers who opened transactions in the current time slot are 70% likely to still be occupying seats at the end of the current time slot). Finally, assume an average consumer count of 1.8. Then the capacity count is ((300−240)×70%+(265−200)×30%)×1.8 =92.7.

In one embodiment, average transaction duration can be used to determine the capacity count. For example, the CM computing device receives transaction data for a consumer's transaction at a merchant (e.g., a bar) and recalculates capacity accordingly. However, if average transaction duration for the bar is known, the CM computing device can predict a transaction close time (i.e., when the consumer will vacate the bar). The CM computing device adds the average transaction duration to the transaction open time to determine a predicted transaction close time. The CM computing device updates the capacity count for the bar accordingly, by either incrementing the capacity count at the predicted transaction close time, or even doing so in advance.

In still other implementations, the CM computing device receives transaction data and uses it in conjunction with total occupancy data and average consumer count data to provide a running measure of capacity. For example, the CM computing device is configured to set the current capacity count equal to total capacity at the start time for a restaurant (e.g., 40 seats). The CM computing device is further configured to receive real-time transactions from the restaurant and reduce the current capacity count by the average consumer count (e.g., 2 consumers). For example, the CM computing device reduces the current capacity count (40) by the average consumer count (2), for each new transaction that is received. In this embodiment, the CM computing device also increments the capacity count by 2 when transaction close time for a transaction is determined, whether via a calculation using average transaction duration, a cardswipe timestamp, or the like.

In other embodiments, the CM computing device receives the actual consumer count as part of order data or transaction data. For example, a restaurant employee will enter “party of 4” in the merchant device or POS device. The CM computing device receives this actual consumer count and is configured to decrement the current capacity count by 4.

In at least some implementations, where the CM computing device receives the transaction open time (e.g., when a restaurant employee transmits an order to the kitchen) the CM computing device may also be configured to add an “order start time” as well (i.e., a predefined number of minutes before the order was entered to account for consumers sitting down and occupying the seats). For example, a restaurant employee may mark a table of, for example, 4 consumers as occupied the minute a party of four consumers is welcomed and seated. The CM computing device will receive transaction open time and a consumer count of 4. But in other instances, consumers are welcomed, seated, and offered drinks, but the restaurant employee does not initiate the order until several minutes later. In such cases the CM computing device appends order start time to the received transaction open time to determine a true transaction open time, thereby more accurately determining when consumers occupied a table and thus affected the restaurant's capacity. For other implementations involving bars, the CM computing device may receive transaction open and close time (e.g., if a tab is opened and later closed for a bar transaction), and associate those times to a predefined time slot.

In at least some implementations, the CM computing device also receives crowdsourced feedback via a software application running on the consumer computing device. Consumers will provide feedback on whether the provided capacity count was accurate. The CM computing device is configured to use this feedback to further refine its determinations of average peak transaction counts, current transaction counts, and average consumer counts in order to provide more accurate measures of capacity in, for example, a restaurant or bar.

The technical problems addressed by this system include at least one of: (i) an inability to integrate transaction data and order data to accurately determine restaurant occupancy and capacity, (ii) under- or non-utilization of order data in determining restaurant occupancy and capacity, and (iii) limitations of restaurant computer applications in providing capacity data to restaurant consumers.

The methods and systems described herein may be implemented using computer programming or engineering techniques including computer software, firmware, hardware, or any combination or subset thereof, wherein the technical effects may be achieved by performing at least one of the following steps: (a) receiving merchant data for a merchant via a merchant computing device, (b) receiving payment transaction data for at least one transaction performed at the merchant via a point-of-sale (POS) computing device, wherein merchant data includes an average consumer count and a total occupancy count, (c) calculating a peak transaction count for the merchant for a predetermined time period, (d) calculating a current transaction count corresponding to a current transaction time included within the predetermined time period, (e) determining a capacity count for the predetermined time period based, at least in part, on the peak transaction count, the current transaction count, and the average consumer count, and (f) transmitting the capacity count to a consumer computing device, wherein the capacity count indicates a current remaining consumer capacity for the merchant.

The resulting technical effects achieved by this system include at least one of: (i) reduced load on merchant devices because of fewer consumer queries regarding capacity for the merchants, (ii) more standardized and streamlined merchant systems that need not track capacity at their individual merchant locations since it is being tracked by the CM computing device, and (iii) efficient delivery of capacity data to consumers using a singular client computer application. Thus, the system enables consumers to receive accurate measures of capacity at, for example, any desired restaurant or bar.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable storage medium. In an example embodiment, the system is executed on a single computer system, without requiring a connection to a server computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile computing devices, or desktop, laptop computing devices, or the like. Each type of transaction card can be used as a method of payment for performing a transaction. As used herein, the term “payment account” is used generally to refer to the underlying account with the transaction card.

The following detailed description illustrates embodiments of the disclosure by way of example and not by way of limitation. It is contemplated that the disclosure has general application to financial transactions in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

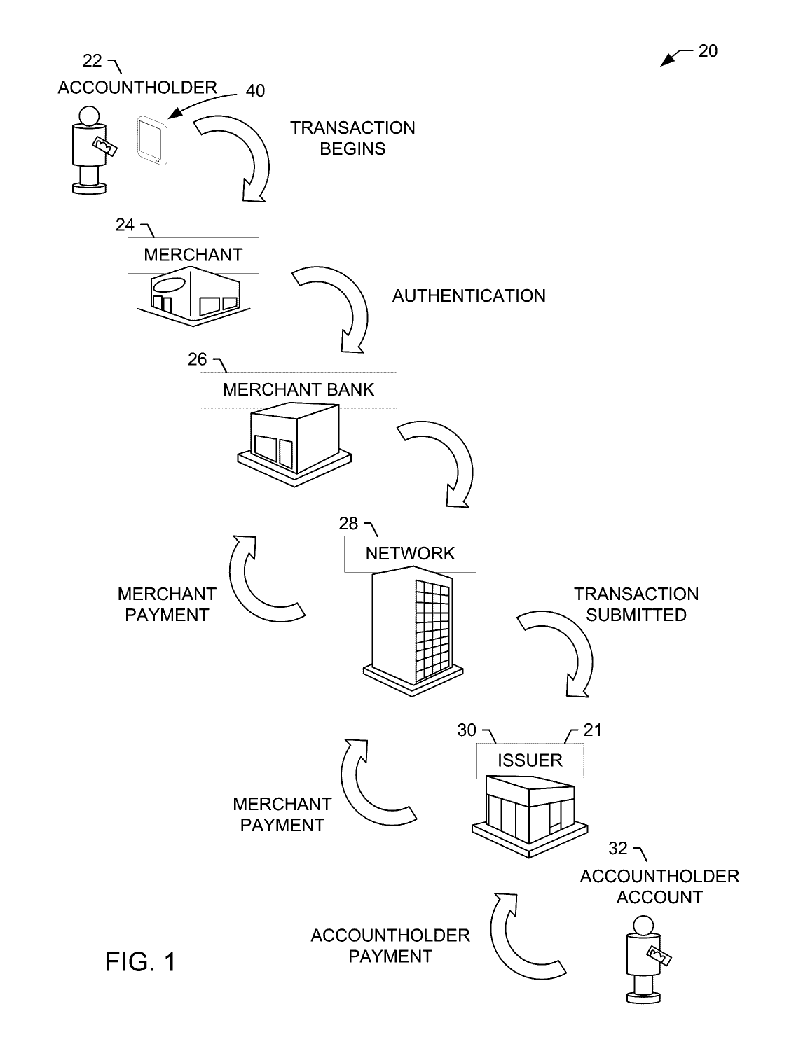

FIG. 1 is a schematic diagram illustrating an example multi-party transaction card industry system 20 for authorizing payment card transactions in which parties provide processing services to various financial entities. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to the consumer or accountholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” In one embodiment, accountholder 22 tenders payment for a purchase using a transaction card at a transaction processing device 40 (e.g., a point of sale device), then merchant 24 requests authorization from a merchant bank 26 for the amount of the purchase. The request is usually performed through the use of a point-of-sale terminal, which reads accountholder 22's account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether accountholder 22's account 32 is in good standing and whether the purchase is covered by accountholder 22's available credit line. Based on these determinations, the request for authorization will be declined or accepted. If the request is accepted, an authorization code is issued to merchant 24.

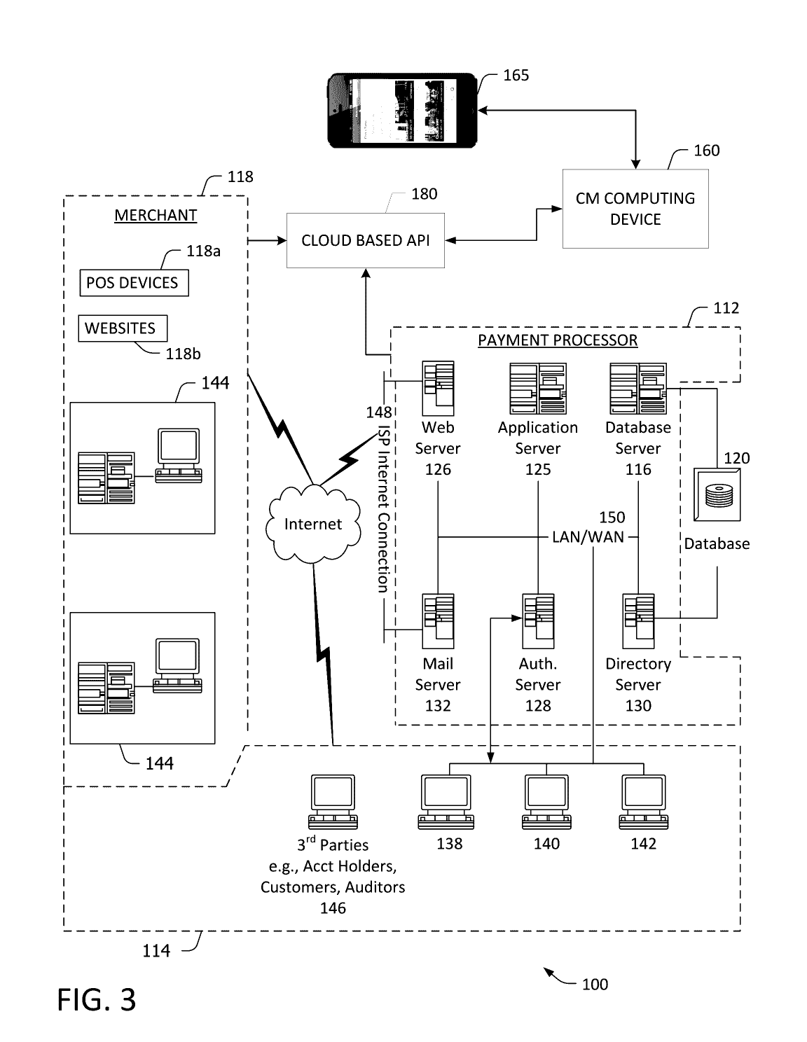

When a request for authorization is accepted, the available credit line of accountholder 22×s account 32 is decreased. Normally, a charge for a payment card transaction is not posted immediately to accountholder 22's account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If accountholder 22 cancels a transaction before it is captured, a “void” is generated. If accountholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 3).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 24, merchant bank 26, and issuer bank 30. Settlement refers to the transfer of financial data or funds among merchant 24's account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described above, the various parties to the payment card transaction include one or more of the parties shown in FIG. 1 such as, for example, accountholder 22, merchant 24, merchant bank 26, interchange network 28 (also referred to herein as payment processor 28), issuer bank 30, and/or an issuer processor 21.

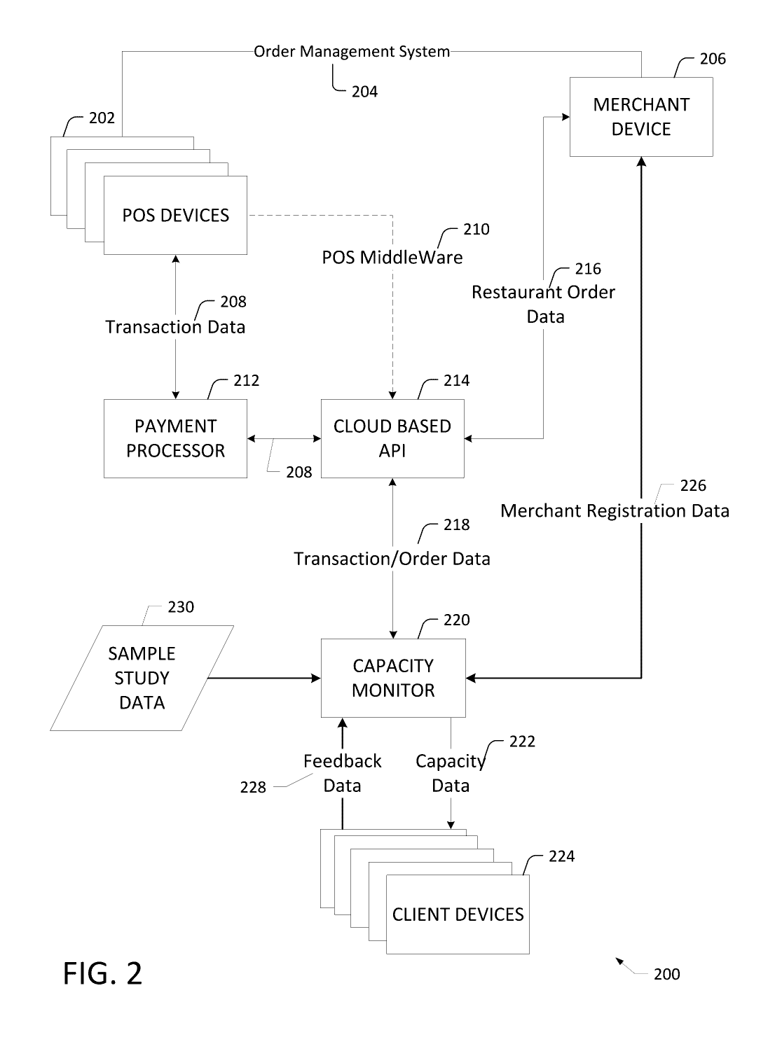

FIG. 2 is a simplified data flow diagram of an example capacity monitoring system 200. System 200 shows a plurality of POS devices 202 connected to at least one merchant device 206 through order management system 204. In one embodiment, order management system 204 is responsible for inventory management and order fulfillment processes. POS devices 202 may include a POS device hosted by a merchant operating merchant device 206. For example, a server at a restaurant may use a merchant device 206 to enter meal orders and a POS device 204 to swipe consumer cards and charge consumers for their meals. In the example embodiment, POS devices 202 include many other POS devices (e.g., at other merchants), not just the POS device associated with merchant device 206.

POS devices 202 also connect to a cloud-based API platform 214 via POS middleware 210, an intermediate software or hardware layer. POS devices 202 also connect to a payment processor 212 (similar to interchange network 28 shown in FIG. 1) and transmit transaction data 208 generated from payment card transactions. In one embodiment, payment processor 212 processes payment transactions performed using payment cards issued by issuing banks that are members of a specific payment processing network. API platform 214 is connected to payment processor 212 and receives transaction data 208 from payment processor 212. API platform 214 also receives order data 216 from merchant device 206. API platform 214 is further connected to capacity monitor computing device 220, and transmits transaction/order data 218 to capacity monitor computing device 220. Additionally, merchant device 206 also connects with capacity monitor computing device 220 to transmit merchant registration data 226. And capacity monitor computing device 220 receives sample study data 230 generated from sample studies or surveys of various restaurants and bars in a particular area. Capacity monitor computing device 220 transmits capacity data 222 to one or more client devices 224. Capacity monitor computing device 220 receives feedback data 228 from client devices 224.

In the example embodiment, a merchant operates merchant device 206 and one or more of POS devices 202 and registers for a capacity monitoring service provided by capacity monitor computing device 220 by transmitting merchant registration data 226. Merchant registration data 226 may include a merchant identifier, merchant type, (restaurant, bar, etc.) total occupancy for the merchant, and historical data such as daily consumer totals, daily transaction totals, seasonal variations, or the like. In one embodiment, merchant registration data 226 is in the form of a spreadsheet, table, or database containing historical transaction data as stored by the merchant.

In the example embodiment, a consumer (e.g., accountholder 22 in FIG. 1) arrives, along with a friend, at a restaurant where the restaurant owner operates merchant device 206 and POS devices 202. Merchant device 206 and POS devices 202 may be the same physical device, the same physical device running different software modules, two connected devices, two unconnected devices, or the like. In one embodiment, a restaurant employee enters the orders for the consumer and his friend into merchant device 206. This generates order data 216, including a consumer count of “2” and additional order data such as items purchased, transaction open time, date, items purchased, a merchant identifier, or the like.

At some point during the consumer's visit, such as when the order is entered or at the end of the visit, the employee also charges the consumer's payment card for the items purchased using one of POS devices 202. Charging the consumer's payment card generates transaction data 208 (e.g., merchant identifier, transaction date, transaction time, transaction amount, cardholder name, expiration date, security code, etc.). Transaction data 208 is transmitted to payment processor 212 and the transaction is processed in a manner similar to that described with respect to FIG. 1. In addition to transaction processing, payment processor 212 transmits transaction data 208 to API platform 214. In an alternative embodiment, API platform 214 receives transaction data directly from POS devices 202 using POS middleware 210. In this alternative embodiment, API platform 214 receives transaction data 208 but also transaction data for transactions performed using payment cards that are not affiliated with the specific payment processor 212. Accordingly, API platform 214 receives transaction data for payment cards that are issued as part of any payment processing network, not just the payment processing network that has payment processor 212 as a member.

API platform 214 transmits transaction and order data 218 to capacity monitor computing device 220. Capacity monitor computing device 220 processes transaction and order data 218 along with merchant registration data 226 to generate a capacity count for the merchant operating merchant device 206. For example, capacity monitor computing device 220 may extract an average consumer count from merchant registration data 226 and/or from sample study data 230. And capacity monitor computing device 220 may extract a current transaction count from transaction and order data 218. Further, capacity monitor computing device 220 may calculate a peak transaction count from historical data developed from previous instances of transaction and order data 218. Accordingly, capacity monitor computing device 220 determines a transaction differential between peak transaction count and current transaction count and then determines a product of the transaction differential and the average consumer count, termed a capacity count, (e.g., the number of available seats in a restaurant). Capacity monitor computing device 220 transmits this product as part of capacity data 222 to one or more client devices 224.

On receipt of capacity data, a consumer operating one or more of client devices 224 has the ability to transmit feedback data 228 to capacity monitor 228. In one embodiment, the consumer may interpret the provided capacity data 222 to mean that a preferred restaurant has available seats, and visit the restaurant. If the consumer finds that seats are indeed available at the restaurant, the consumer may use one of client devices 224 to transmit positive feedback about the quality of capacity data 222. Feedback data 228 may take the form of points, stars, letter grades, multiple-choice question entries, free-form text, or the like. If the restaurant did not have available seats, the consumer may transmit negative feedback. Whether feedback data 228 contains positive or negative feedback, capacity monitor computing device 220 is configured to use feedback to refine its capacity monitoring process. In one embodiment, capacity monitor computing device 220 is configured to receive feedback data 228 and incorporate it into its capacity calculations.

FIG. 3 illustrates an example capacity monitoring environment 100. Environment 100 shows a capacity monitoring (CM) computing device 160 that is specifically programmed to monitor capacity (e.g., an available number of seats) for a merchant such as a restaurant or bar. In the exemplary embodiment, CM computing device 160 communicates with a consumer device 165 to communicate capacity data (e.g., for a particular restaurant or bar). CM computing device 160 is in communication with a cloud-based API platform 180. Cloud-based API platform 180 communicates with various transaction points hosted by a merchant 118, such as a POS device 118a, and/or a website 118b. POS device 118a includes any device designed to receive account data transmitted during a transaction, such as cardswipe devices, magnetic card touch devices, devices enabled with near field communication (NFC) technology, or the like. Merchants also operate websites 118b where consumers may, for example, view menus, get merchant information, order meal/drink items, or the like.

Cloud-based API platform 180 also communicates with one or more merchant devices 144. Merchant devices 144 are interconnected to the network through many interfaces such as a local area network (LAN) or a wide area network (WAN), dial-in-connections, cable modems, special high-speed Integrated Services Digital Network (ISDN) lines, and RDT networks. Merchant devices 144 could be any device capable of interconnecting to the Internet including a mobile computing device, desktop or laptop computing device, or any other web-based connectable equipment. In one embodiment, merchant devices 144 are housed at individual merchant locations, such as restaurants. For example, a restaurant may use a merchant device 144 to enter meal order information, reserve tables, communicate with the kitchen, or the like.

Cloud-based API platform 180 also communicates with one or more payment processors 112. In the exemplary embodiment, payment processor 112 is one or more computing devices associated with a payment processor that processes payment transactions that consumers perform using payment cards. In one embodiment, payment processor 112 represents a group of interconnected computers that includes database server 116, application server 125, web server 126, mail server 132, authentication server 128, and directory server 130, all in communication over a LAN/WAN network 150. In the exemplary embodiment, payment processor 112 communicates with external computers via internet connection 148. Authentication server 128 communicates with remotely located systems, e.g., user computing device 170. Authentication server 128 is also configured to communicate with other workstations 138, 140, and 142 as well.

Payment processor 112 is also in communication with computers 114 that, in the exemplary embodiment, are associated with issuing banks that issue payment cards to consumers. Computers 114 are interconnected to the network through many interfaces including a network 115, such as a local area network (LAN) or a wide area network (WAN), dial-in-connections, cable modems, special high-speed Integrated Services Digital Network (ISDN) lines, and RDT networks. Computers 114 could be any device capable of interconnecting to the Internet including a smartphone, desktop or laptop computer, or other web-based connectable equipment.

Database 120 may include a single database having separated sections or partitions or may include multiple databases, each being separate from each other. Database 120 may store transaction data generated by payment card transactions including data relating to merchants, consumers, issuers, acquirers, or the like. Database 120 may also store capacity data, transaction count data, peak transaction count data, consumer count data, and calculated averages of these and other data points. Database 120 may also store merchant data including a merchant identifier that identifies each merchant, merchant registration data including total occupancy, hours of operation, any merchant preference data such as seasonal variations in capacity, or the like. Database 120 may also store purchase data associated with items being purchased by a cardholder from a merchant, and authorization request data.

In the example embodiment, one of computers 114 may be associated with an acquirer bank while another one of computers 114 may be associated with issuer bank 30 (shown in FIG. 1). Computers 114 may comprise third party computers 146, and issuer devices 138, 140, and 142. CM computing device 160 may be associated with interchange network 28 or a payment processor. In the example embodiment, CM computing device 160 is associated with a network interchange, such as interchange network 28, and may be referred to as an interchange computer system or a payment processing computing device. In addition, computers 114 and/or external hosts 130 may include a computer system associated with at least one of an online bank, a bill payment outsourcer, an acquirer bank, an acquirer processor, an issuer bank associated with a transaction card, an issuer processor, a remote payment system, a token requestor, a token provider, and/or a biller.

In the example embodiment, CM computing device 160 does not consist of generic computer hardware, nor does it require merely generic computer instructions to perform the above functions. Rather, CM computing device 160 is a specific and customized computer device built to perform the specific function of determining and monitoring capacity for one or more merchants and providing capacity information to interested consumers. In the example embodiment, CM computing device 160 is tailored to communicate in specific ways with API platform 180, merchant devices 144, and other processing networks 118. CM computing device 160 is specifically configured to perform one or more of the data manipulation tasks described herein, such as (a) receiving merchant data for a merchant via a merchant computing device, (b) receiving payment transaction data for at least one transaction performed at the merchant via a point-of-sale (POS) computing device, wherein merchant data includes an average consumer count and a total occupancy count, (c) calculating a peak transaction count for the merchant for a predetermined time period, (d) calculating a current transaction count corresponding to a current transaction time included within the predetermined time period, (e) determining a capacity count for the predetermined time period based, at least in part, on the peak transaction count, the current transaction count, and the average consumer count, and (f) transmitting the capacity count to a consumer computing device, wherein the capacity count indicates a current remaining consumer capacity for the merchant.

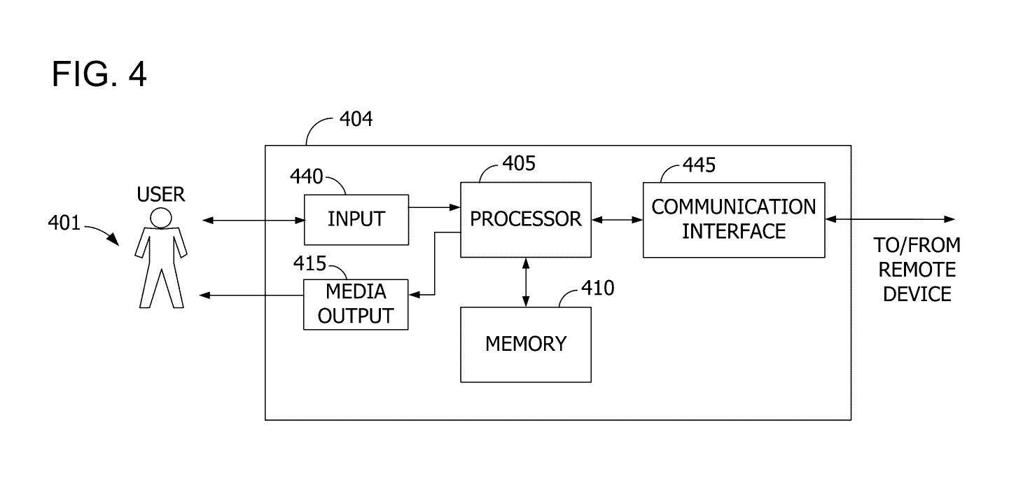

FIG. 4 illustrates an example configuration of a user system 404 operated by a user, such as a merchant or consumer, shown in FIG. 1. User system 404 may include, but is not limited to, merchant computing device 144 or client device 165. In the example embodiment, user system 404 includes a processor 405 for executing instructions. In some embodiments, executable instructions are stored in a memory area 410. Processor 405 may include one or more processing units, for example, a multi-core configuration. Memory area 410 is any device allowing information such as executable instructions and/or written works to be stored and retrieved. Memory area 410 may include one or more computer readable media.

User system 404 also includes at least one media output component 415 for presenting information to user 401. Media output component 415 is any component capable of conveying information to user 401. In some embodiments, media output component 415 includes an output adapter such as a video adapter and/or an audio adapter. An output adapter is operatively coupled to processor 405 and operatively connectable to an output device such as a display device, a liquid crystal display (LCD), organic light emitting diode (OLED) display, or “electronic ink” display, or an audio output device, a speaker or headphones.

In some embodiments, user system 404 includes an input device 440 for receiving input from user 401. Input device 440 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 415 and input device 440. User system 404 may also include a communication interface 445, which is communicatively connectable to a remote device such as payment processor 112. Communication interface 445 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 410 are, for example, computer readable instructions for providing a user interface to user 401 via media output component 415 and, optionally, receiving and processing input from input device 440. A user interface may include, among other possibilities, a web browser and client application. Web browsers enable users, such as user 401, to display and interact with media and other information typically embedded on a web page or a website from payment processor 112. A client application allows user 401 to interact with a server application from, for example, CM computing device 160 in order to receive capacity information.

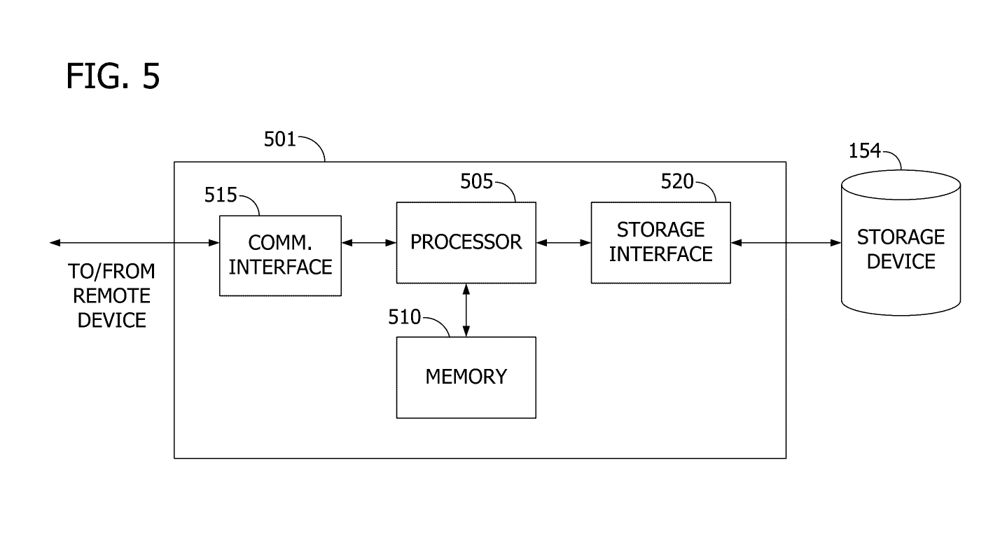

FIG. 5 illustrates an example configuration of a server system such as the CM computing device 160 shown in FIG. 2 used for monitoring capacity. Server system 501 may include, but is not limited to, database server 116, or CM computing device 160 (shown in FIG. 2). In some embodiments, server system 501 is similar to CM computing device 160 (shown in FIG. 2).

Server system 501 includes a processor 505 for executing instructions. Instructions may be stored in a memory area 510, for example. Processor 505 may include one or more processing units (e.g., in a multi-core configuration) for executing instructions. The instructions may be executed within a variety of different operating systems on the server system 501, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 505 is operatively coupled to a communication interface 515 such that server system 501 is capable of communicating with a remote device such as a user system or another server system 501. For example, communication interface 515 may receive requests from computers 114 via the Internet, as illustrated in FIG. 3.

Processor 505 may also be operatively coupled to a storage device 154. Storage device 154 is any computer-operated hardware suitable for storing and/or retrieving data. In some embodiments, storage device 154 is integrated in server system 501. For example, server system 501 may include one or more hard disk drives as storage device 154. In other embodiments, storage device 154 is external to server system 501 and may be accessed by a plurality of server systems 501. For example, storage device 154 may include multiple storage units such as hard disks or solid state disks in a redundant array of inexpensive disks (RAID) configuration. Storage device 154 may include a storage area network (SAN) and/or a network attached storage (NAS) system.

In some embodiments, processor 505 is operatively coupled to storage device 154 via a storage interface 520. Storage interface 520 is any component capable of providing processor 505 with access to storage device 154. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 154.

Memory area 510 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

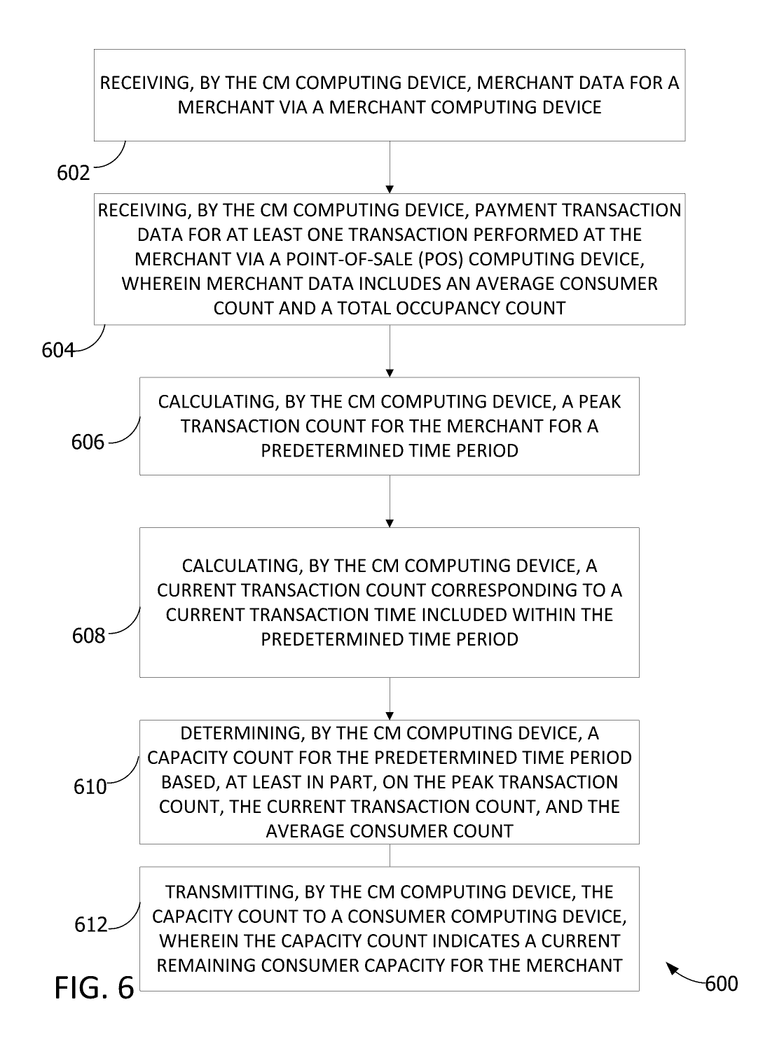

FIG. 6 shows an example method by which the CM computing device monitors and reports capacity. In the example embodiment, the CM computing device receives 602 merchant data for at least one merchant via a merchant computing device. The CM computing device also receives 604 payment transaction data for at least one transaction performed at the merchant via a point-of-sale (POS) computing device, wherein merchant data includes an average consumer count and a total occupancy count. In one embodiment, the transaction performed at the POS device generates transaction data that is transmitted to a payment processor. The payment processor communicates the payment transaction data to the CM computing device, directly or via an API layer configured to receive payment transaction data from a plurality of POS devices. The CM computing device calculates 606 a peak transaction count for the merchant for a predetermined time period. The CM computing device 608 calculates a current transaction count corresponding to a current transaction time included within the predetermined time period. The calculations are performed to generate an output that is provided to a consumer computing device. The CM computing device determines 610 a capacity count for the predetermined time period based, at least in part, on the peak transaction count, the current transaction count, and the average consumer count. The CM computing device transmits 612 the capacity count to a consumer computing device, wherein the capacity count indicates a current remaining consumer capacity for the merchant. The calculated capacity count enables a consumer to see (e.g., in 30- or 45-minute segments) a real-time capacity of a restaurant or bar in order to determine whether or not to visit the restaurant or bar.

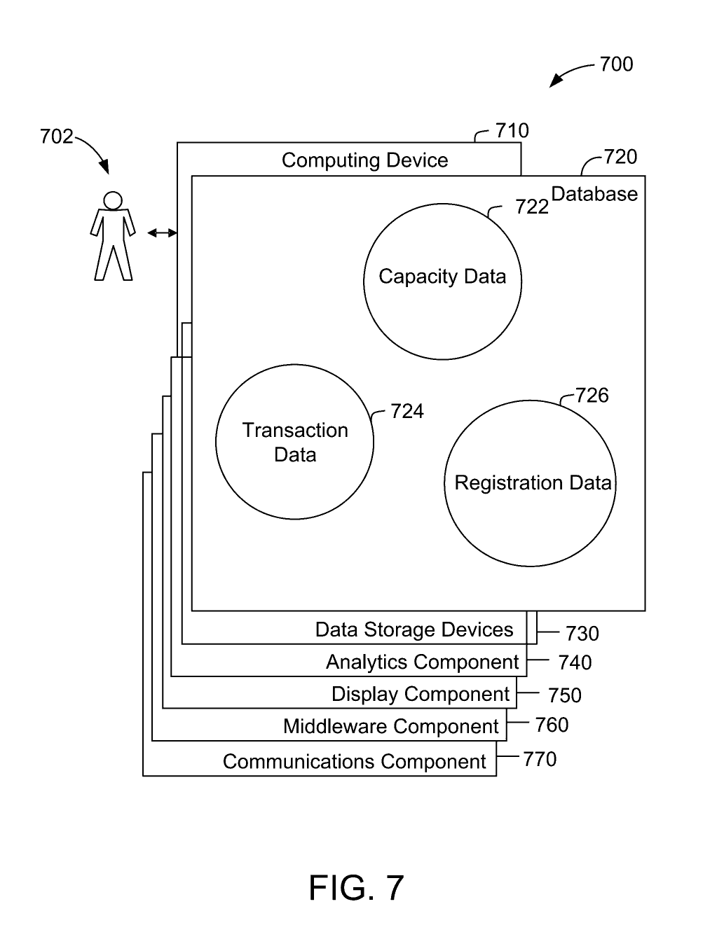

FIG. 7 shows an example configuration of a database 700 within a computing device, along with other related computing components, that may be used to monitor capacity for a merchant. In some embodiments, computing device 710 is similar to CM computing device 160 (shown in FIG. 2). User 702 may access computing device 710 in order to request capacity information for, for example, a restaurant or bar. In some embodiments, database 720 is similar to database 120 (shown in FIG. 2). In the example embodiment, database 720 includes capacity data 722, payment transaction data 724, and registration data 726. Capacity data 722 includes data regarding capacity counts, average consumer counts, and total occupancy counts for one or more merchants. Payment transaction data 724 includes data about transaction counts (including peak transaction counts), transaction data such as transaction date, time, merchant ID, or the like. Registration data 726 includes merchant-provided data regarding, for example, a merchant's restaurant capacity, hours of operation, type of POS device and merchant device, or the like.

Computing device 710 also includes data storage devices 730. Computing device 710 also includes an analytics component 740 configured to determine data points involved in capacity monitoring (e.g., peak transaction count, transaction differential, capacity count, etc.). Computing device 710 also includes display component 750 that is at least configured to render various displays of capacity to consumers (e.g., a map display on a consumer device showing restaurants with available capacity). Computing device 710 also includes middleware component 760 that is configured to communicate with an API platform that receives transaction and order data from multiple POS devices and merchant devices. Computing device 710 also includes communications component 770 which is used to communicate at least with consumers and merchants (e.g., to transmit capacity data to consumers, to receive merchant registration data from merchants, or the like).

As will be appreciated based on the foregoing specification, the above-described embodiments of the disclosure may be implemented using computer programming or engineering techniques including computer software, firmware, hardware or any combination or subset thereof, wherein the technical effect is to determine capacity for a merchant such as a restaurant or bar. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-based method for reporting capacity for a merchant, the method implemented using a capacity monitoring (CM) computing device in communication with a processor and a memory device, the method comprising:
receiving, by the CM computing device, merchant data for a merchant via a merchant computing device, wherein merchant data includes an average consumer count and a total occupancy count;
receiving, by the CM computing device, payment transaction data for at least one transaction performed at the merchant via a point-of-sale (POS) computing device;
calculating, by the CM computing device, a peak transaction count for the merchant for a predetermined time period;
calculating, by the CM computing device, a current transaction count corresponding to a current transaction time included within the predetermined time period;
determining, by the CM computing device, a capacity count for the predetermined time period based, at least in part, on the peak transaction count, the current transaction count, and the average consumer count; and
transmitting, by the CM computing device, the capacity count to a consumer computing device, wherein the capacity count indicates a current remaining consumer capacity for the merchant.

2. A method in accordance with claim 1, wherein determining the peak transaction count further comprises:
dividing the predetermined time period into one or more sub-periods;
determining a maximum transaction count for each sub-period; and
calculating an average of the maximum transaction counts for all sub-periods within the time period.

3. A method in accordance with claim 1, wherein determining the capacity count further comprises:
determining a transaction differential by subtracting the current transaction count from the peak transaction count;
computing a first product of the average consumer count and a transaction differential; and
assigning the first product to a capacity count variable.

4. A method in accordance with claim 1, wherein determining the capacity count further comprises:
computing a second product of the average consumer count and the current transaction count;
subtracting the second product from the total occupancy count; and
assigning a result of the subtraction to the capacity count variable.

5. A method in accordance with claim 1, wherein determining the capacity count further comprises:
calculating an average transaction duration, further comprising subtracting the transaction start time from the transaction end time for one or more transactions and dividing a result of the subtraction by a total of the one or more transactions; and
incrementing the capacity count by the average consumer count when a time interval equal to the average transaction duration has elapsed after the transaction start time for the at least one transaction.

6. A method in accordance with claim 1, further comprising:
extracting a transaction start time and transaction end time for the at least one transaction from the transaction data;
associating the transaction start time and the transaction end time with the time period; and
associating the at least one transaction with the time period.

7. A method in accordance with claim 1, further comprising:
receiving feedback data from the client device, wherein feedback data represents an accuracy indicator of the available capacity count output to the client device.

8. A computer system for reporting capacity for a merchant, the system comprising a capacity monitoring (CM) computing device configured to:
receive merchant data for a merchant via a merchant computing device, wherein merchant data includes an average consumer count and a total occupancy count;
receive payment transaction data for at least one transaction performed at the merchant via a point-of-sale (POS) computing device;
calculate a peak transaction count for the merchant for a predetermined time period;
calculate a current transaction count corresponding to a current transaction time included within the predetermined time period;
determine a capacity count for the predetermined time period based, at least in part, on the peak transaction count, the current transaction count, and the average consumer count; and
transmit the capacity count to a consumer computing device, wherein the capacity count indicates a current remaining consumer capacity for the merchant.

9. A system in accordance with claim 8 wherein, to determine the peak transaction count, the CM computing device is further configured to:
divide the predetermined time period into one or more sub-periods;
determine a maximum transaction count for each sub-period; and
calculate an average of the maximum transaction counts for all sub-periods within the time period.

10. A system in accordance with claim 8, wherein, to determine the capacity count, the CM computing device is further configured to:
determine a transaction differential by subtracting the current transaction count from the peak transaction count;
compute a first product of the average consumer count and a transaction differential; and
assign the first product to a capacity count variable.

11. A system in accordance with claim 8, wherein, to determine the capacity count, the CM computing device is further configured to:
compute a second product of the average consumer count and the current transaction count;
subtract the second product from the total occupancy count; and
assign a result of the subtraction to the capacity count variable.

12. A system in accordance with claim 8 wherein, to determine the capacity count, the CM computing device further configured to:
calculate an average transaction duration, further comprising subtracting the transaction start time from the transaction end time for one or more transactions and dividing a result of the subtraction by a total of the one or more transactions; and
increment the capacity count by the average consumer count when a time interval equal to the average transaction duration has elapsed after the transaction start time for the at least one transaction.

13. A system in accordance with claim 8, wherein the CM computing device is further configured to:
extract a transaction start time and transaction end time for the at least one transaction from the transaction data;
associate the transaction start time and the transaction end time with the time period; and
associate the at least one transaction with the time period.

14. A system in accordance with claim 8, wherein the CM computing device is further configured to:
receive feedback data from the client device, wherein feedback data represents an accuracy indicator of the available capacity count output to the client device.

15. A non-transitory computer readable medium that includes computer executable instructions for reporting capacity for a merchant, wherein when executed by a capacity monitoring (CM) computing device in communication with a processor and a memory device, the computer executable instructions cause the CM computing device to:
receive merchant data for a merchant via a merchant computing device, wherein merchant data includes an average consumer count and a total occupancy count;
receive payment transaction data for at least one transaction performed at the merchant via a point-of-sale (POS) computing device;
calculate a peak transaction count for the merchant for a predetermined time period;
calculate a current transaction count corresponding to a current transaction time included within the predetermined time period;
determine a capacity count for the predetermined time period based, at least in part, on the peak transaction count, the current transaction count, and the average consumer count; and
transmit the capacity count to a consumer computing device, wherein the capacity count indicates a current remaining consumer capacity for the merchant.

16. A non-transitory computer readable medium in accordance with claim 15 wherein, to determine the peak transaction count, the computer executable instructions cause the CM computing device to:
divide the predetermined time period into one or more sub-periods;
determine a maximum transaction count for each sub-period; and
calculate an average of the maximum transaction counts for all sub-periods within the time period.

17. A non-transitory computer readable medium in accordance with claim 15, wherein, to determine the capacity count, the computer executable instructions cause the CM computing device to:
determine a transaction differential by subtracting the current transaction count from the peak transaction count;
compute a first product of the average consumer count and a transaction differential; and
assign the first product to a capacity count variable.

18. A non-transitory computer readable medium in accordance with claim 15, wherein, to determine the capacity count, the computer executable instructions cause the CM computing device to:
compute a second product of the average consumer count and the current transaction count;
subtract the second product from the total occupancy count; and
assign a result of the subtraction to the capacity count variable.

19. A non-transitory computer readable medium in accordance with claim 15 wherein, to determine the capacity count, the computer executable instructions cause the CM computing device to:
calculate an average transaction duration, including subtracting the transaction start time from the transaction end time for one or more transactions and dividing a result of the subtraction by a total of the one or more transactions; and
increment the capacity count by the average consumer count when a time interval equal to the average transaction duration has elapsed after the transaction start time for the at least one transaction.

20. A non-transitory computer readable medium in accordance with claim 15, further comprising:
extracting a transaction start time and transaction end time for the at least one transaction from the transaction data;
associating the transaction start time and the transaction end time with the time period; and
associating the at least one transaction with the time period.
